(19) United States
(12) Patent Application Publication
(10) Pub. No.: US 2017/0036773 A1
(43) Pub. Date: Feb. 9, 2017

(54) INFLIGHT POWER MANAGEMENT FOR AIRCRAFT

(71) Applicant: PRATT & WHITNEY CANADA CORP., Longueuil (CA)

(72) Inventors: Anthony JONES, San Diego, CA (US); Andre JULIEN, Sainte-Julie (CA); David MENHEERE, Norval (CA); Jean THOMASSIN, Sainte-Julie (CA); Richard ULLYOTT, Saint-Bruno (CA); Daniel VAN DEN HENDE, Mississauga (CA)

(21) Appl. No.: 15/212,883

(22) Filed: Jul. 18, 2016

Related U.S. Application Data
(60) Provisional application No. 62/202,297, filed on Aug. 7, 2015.
(60) Provisional application No. 62/202,275, filed on Aug. 7, 2015.

(51) Int. Cl. B64D 31/06; B64D 27/10; B64D 27/16; B64D 41/00

(52) U.S. Cl. CPC B64D 31/06; B64D 41/00; B64D 27/10; B64D 27/16; B64D 2221/00

(57) ABSTRACT

There is described herein methods and systems for selective use of an auxiliary power source inflight in order to reduce fuel consumption of an aircraft.

### TECHNICAL FIELD

The application relates generally to the use of an auxiliary power source in an aircraft, and more particularly, to selectively activating the auxiliary power source during flight.

### BACKGROUND OF THE ART

Aircraft secondary power in flight is generally provided by extracting bleed air from the main engine compressors and shaft power for driving generators and hydraulic pumps. Bleed air is typically used for cabin pressurization and/or de-icing, while shaft power is used for electrical generation and hydraulics.

Due to the design of modern propulsion engines, secondary extracted power may be obtained at fairly high thermal efficiency in certain flight regimes, such as cruise or climb. However in certain situations, such as during descent or other limited cruise conditions, the loads deviate from the design values or the engine operates at partial load. In such cases, the secondary power is obtained at much reduced thermal efficiency.

Therefore, there is a need to improve on existing methods for providing secondary power in flight.

### SUMMARY

There is described herein methods and systems for selective use of an auxiliary power source inflight in order to reduce fuel consumption of an aircraft.

In one aspect, there is provided a method for power management in an aircraft having at least one main power source for providing propulsive power to the aircraft and at least one auxiliary power source for providing auxiliary power to the aircraft. The method comprises, while in flight, receiving auxiliary power source current operating conditions from at least one auxiliary power source and receiving main power source current operating conditions from at least one main power source; receiving an actual load power requirement for the aircraft; determining an allocation of power loads of the aircraft for the actual load power requirements, based on the current operating conditions, to minimize fuel consumption of the aircraft; and distributing the power loads of the aircraft between the at least one auxiliary power source and the at least one main power source in accordance with the allocation as determined.

In another aspect, there is provided a power management system for an aircraft having at least one main power source for providing propulsive power to the aircraft and at least one auxiliary power source for providing auxiliary power to the aircraft. The system comprises a processing unit and a non-transitory memory communicatively coupled to the processing unit and comprising computer-readable program instructions. The program instructions are executable by the processing unit for, while in flight, receiving auxiliary power source current operating conditions from at least one auxiliary power source and receiving main power source current operating conditions from at least one main power source; receiving an actual load power requirement for the aircraft; determining an allocation of power loads of the aircraft for the actual load power requirements, based on the current operating conditions, to minimize fuel consumption of the aircraft; and distributing the power loads of the aircraft between the at least one auxiliary power source and the at least one main power source in accordance with the allocation as determined.

In yet another aspect, there is provided a power management system for an aircraft having at least one main power source for providing propulsive power to the aircraft and at least one auxiliary power source for providing auxiliary power to the aircraft. The system comprises at least one main power source, at least one auxiliary power source, and a controller configured for, while in flight, receiving auxiliary power source current operating conditions from at least one auxiliary power source and receiving main power source current operating conditions from at least one main power source; receiving an actual load power requirement for the aircraft; determining an allocation of power loads of the aircraft for the actual load power requirements, based on the current operating conditions, to minimize fuel consumption of the aircraft; and distributing the power loads of the aircraft between the at least one auxiliary power source and the at least one main power source in accordance with the allocation as determined.

### DESCRIPTION OF THE DRAWINGS

Reference is now made to the accompanying figures in which:

FIG. 1 is a block diagram of an example aircraft;

FIG. 2 is a schematic cross-sectional view of a gas turbine engine;

FIGS. 3A-3D are schematic views of a compound engine assembly in accordance with particular embodiments;

FIG. 4 is a flowchart of an example method for power management in an aircraft; and

FIG. 5 is a block diagram of an example computing device for implementing a power management controller.

### DETAILED DESCRIPTION

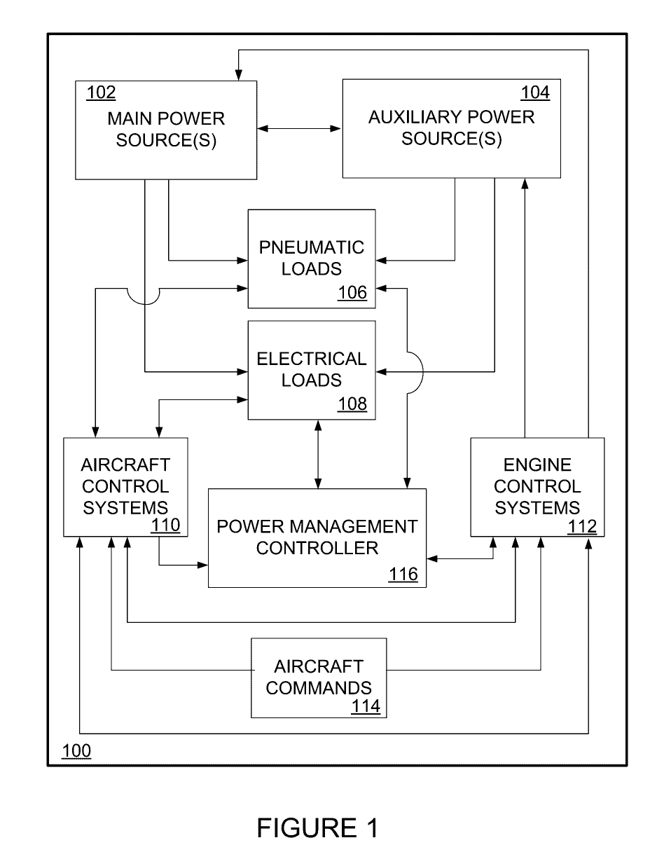

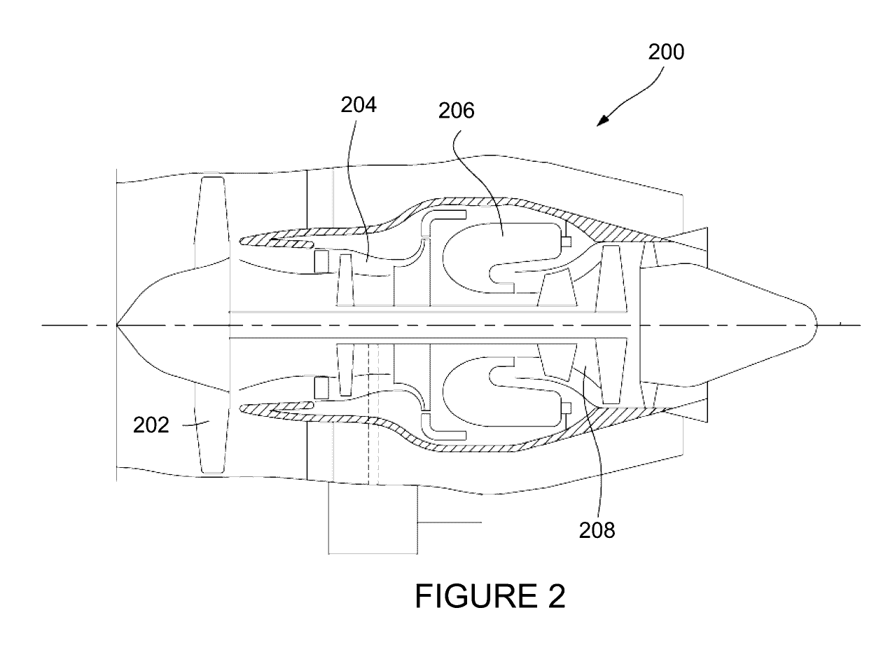

With reference to FIG. 1, there is illustrated an aircraft 100 having at least one main power source 102 and at least one auxiliary power source 104. The aircraft 100 may be any type of aircraft 100 with an engine, such as a fixed-wing aircraft, a rotary-wing aircraft, and a jet aircraft. The main power source 102 may comprise one or more gas turbine engines, such as the one illustrated in FIG. 2. Engine 200 generally comprises, in serial flow communication, a propeller 202 through which ambient air is propelled, a compressor section 204 for pressurizing the air, a combustor 206 in which the compressed air is mixed with fuel and ignited for generating an annular stream of hot combustion gases, and a turbine section 208 for extracting energy from the combustion gases. While engine 200 is a turbofan engine, the main power source 102 may also comprise one or more other type of gas turbine engines, such as turboprop engines and turboshaft engines. Alternatively, or in combination therewith, other types of internal combustion engines may also be used.

The at least one auxiliary power source 104 provides secondary power to the aircraft 100 inflight. The auxiliary power source 104 may comprise engine assemblies of a same or different type as the main power source 102. In some embodiments, the auxiliary power source 104 comprises one or more compound engine assemblies such as the compound assemblies of the type disclosed in the provisional application entitled COMPOUND ENGINE ASSEMBLY APU WITH INTEGRAL COOLING SYSTEM, filed under No. 62/202,275 on Aug. 7, 2015 (hereinafter, “the co-pending application”), which is incorporated by reference herein in its entirety.

Such compound engine assemblies generally include a supercharger compressor compressing the air to feed an engine core including one or more internal combustion engines. The supercharger compressor may also provide bleed air for the aircraft, or an additional compressor may be provided for that use. The internal combustion engines in the embodiments shown and described herein are rotary engines, for example Wankel engines, but it is understood that other types of internal combustion engines may alternately be used. The exhaust from the engine core is fed to one or more turbines of a compounding turbine section. The compressor may be driven by the turbine section and/or the engine core. The turbine section is configured to compound power with the engine core shaft.

Such compound engine assemblies can be used as auxiliary power units (APU), or more generally auxiliary power sources. Increased in flight operation of this type of APU can be contemplated because the thermal efficiency is much more comparable to the main engines (prime mover engines) than conventional gas turbine APUs. Two scenarios can be envisaged: Full time APU operation with no main engine bleed and shaft horse power (shp) extraction, and part time APU operation where the APU is only operated when it is in flight regimes where the efficiency is superior and fuel can be saved. For full time operation there may be additional savings if the main engines are re-optimized for propulsion only duties. Part time operation is managed to extract savings and represents an interesting stepping stone in that system failures can be mitigated by reverting back to conventional main bleed and extraction.

In some embodiments, the main power source 102 is also a compound engine assembly, such as the ones illustrated herein or as described in the co-pending application, suitably sized to provide adequate power.

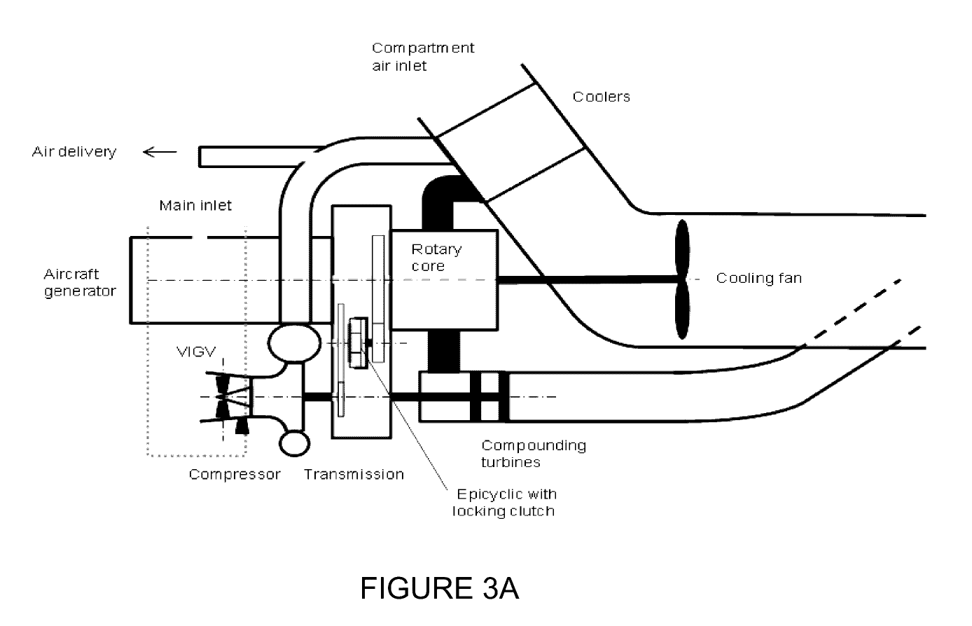

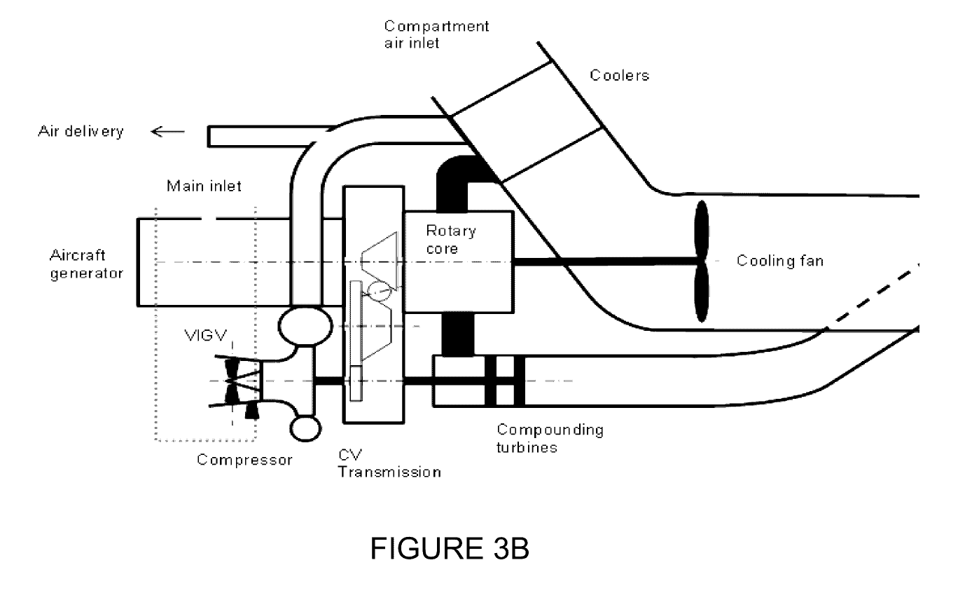

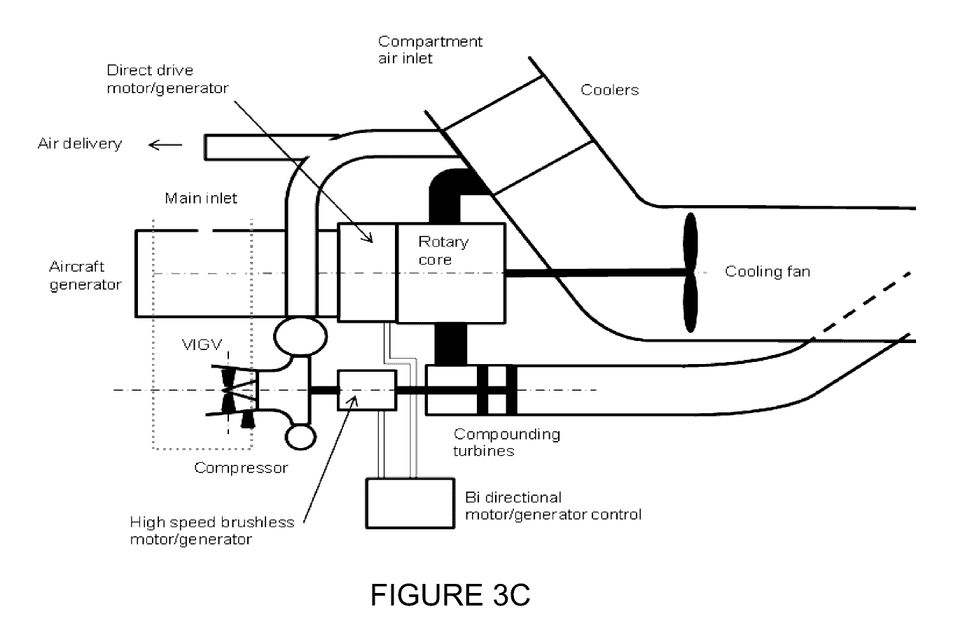

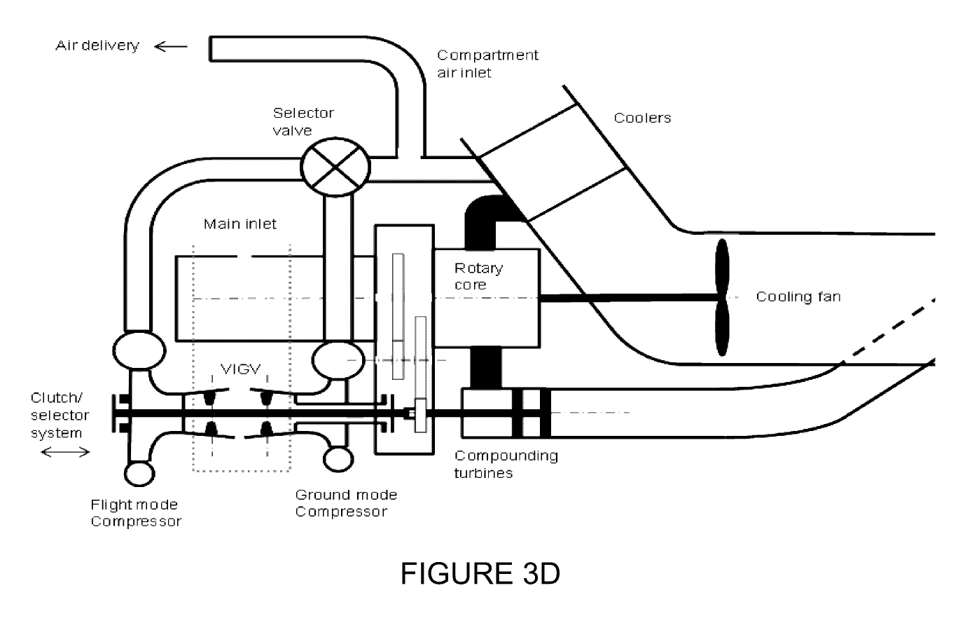

FIGS. 3A to 3D show examples of configurations for compound engine assemblies that may be used as the one or more auxiliary power source 104. In the embodiment of FIG. 3A, a two (or more) speed transmission between the compressor/turbine shaft and the engine core shaft provides a high speed, high pressure range for altitude operation and a low speed range for ground and low altitude use. In the embodiment shown, an epicyclic type stage is used with a friction brake/clutch and lock to provide a means of obtaining a two speed operation. Depending on the design, the auxiliary power source could shift by cycling through a low transmission power condition and effect the lock unlock, or it could require to be shut down and require to be re-started after shifting the transmission.

In the embodiment of FIG. 3B, a continuously variable transmission (CVT) is provided between the engine core shaft and the compressor/turbine shaft. In a particular embodiment, such a configuration provides better optimization capability than the embodiment of FIG. 3A. In a particular embodiment, the CVT is in the low speed area of the gearbox associated with the engine (e.g. 8000 rpm for a rotary engine core) and in a configuration where the engine core/turbine work-split minimizes the power to be transmitted via the CVT for efficiency, heat generation and weight reasons.

In the embodiment of FIG. 3C, an electric link is provided with motor/generator units on the compressor/turbine shaft and the engine core shaft, to transfer power with variable speed drive capability. The electric link is bi-directional, meaning that it can adapt to transfer power from the engine core shaft to the compressor/turbine shaft and vice versa, so that excess power from the compressor/turbine shaft can be transferred to the engine core shaft when appropriate.

The embodiment of FIG. 3D includes separate compressors for ground and flight modes. The ground mode compressor is designed for moderate pressure ratio and the flight mode compressor is designed for high altitude requirements. A clutch system is included in the transmission to select the appropriate compressor to drive based on an input from the aircraft control systems indicating the status of the aircraft.

In some embodiments, the auxiliary power source 104, may have a configuration such as shown in the co-pending application, with either a shared compressor or separate driven compressor. As the altitude rises it is anticipated that the super-charge pressure and the delivery pressure requirement to the ECS system will both rise such that a common compressor may be possible. The compressor VIGV setting will be regulated to match the aircraft pneumatic system pressure requirement. Fuel air ratio in the rotary engine will be controlled to provide governed speed operation. Where the pneumatic and supercharger delivery pressure requirements do not reasonably follow each other, separate compressor supercharger and load compressors are employed, each controlled to meet the respective delivery air requirements.

Referring back to FIG. 1, aircraft 100 comprises various loads, illustratively provided as pneumatic loads 106 and electrical loads 108. The electrical loads 108 correspond to any aircraft electrical system or device that generates, transmits, distributes, utilises, and/or stores electrical energy. For example, the electrical loads may include an electric starter, lights, electric flight instruments, navigation aids, and radios. One or more distribution bus (not shown) is provided in the aircraft 100 to power individual components of the electrical loads 108. The pneumatic loads 106 correspond to any aircraft system or device that is generally powered by compressed air or compressed inert gases, such as brakes, compressors, actuators, pressure sensors, pressure switches, pressure regulators, and the like.

The loads 106, 108 may be powered by the main power source 102, the auxiliary power source 104, or both. Aircraft control systems 110 are operatively connected to the electrical loads 108 for selectively allocating the electrical loads 108 to the main power source 102 and/or the auxiliary power source 104. For example, a switching device (not shown) may be used to connect the electrical loads 108 to an AC generator of the main power source 102 and/or an AC generator of the auxiliary power source 104. Other mechanisms for selectively connecting the electrical loads to the power sources 102, 104 may also be used. The aircraft control systems 110 are also operatively connected to the pneumatic loads 106, for selectively allocating the pneumatic loads 106 to the main power source 102 and/or the auxiliary power source 104. For example, the aircraft control systems 110 may control one or more valves between the auxiliary power sources 104 and the pneumatic loads 106, and between the main power source 102 and the pneumatic loads 106, so as to distribute the loads partially or fully to either one of the power sources 102, 104.

The aircraft control systems 110 may comprise any system for control of the aircraft 100, such as a flight management system (FMS), an air management system, an aircraft management controller (AMC), an aircraft digital computer system, and the like. In some embodiments, various information is transmitted from one aircraft control system to another, such as flight mode or regime (i.e. take-off, climb, cruise, descent, taxi, etc.) and other aircraft operating parameters (i.e. pressure, temperature, speed, etc.). The aircraft control systems 110 are also connected to aircraft commands 114, which may comprise primary controls such as a control yoke, a center stick or side stick, rudder pedals, and throttle controls, and/or secondary controls, for receiving from the aircraft commands 114 control signals for control of the aircraft 100. The aircraft commands 114 are also connected to engine control systems 112, which may comprise any engine controlling devices such as an engine control unit (ECU), an engine electronic controller (EEC), an engine electronic control system, and a Full Authority Digital Engine Controller (FADEC). The engine control systems 112 may be configured for starting and shutting down the auxiliary power sources 104, as well as for effecting other control operations on the power sources 102, 104. The engine control systems 112 are operatively connected to the aircraft control systems 110 for exchanging information therebetween, such as operating conditions of the auxiliary power sources 104 and/or operating conditions of the main power sources 102.

Aircraft 100 also comprises a power management controller 116, operatively connected between the aircraft control systems 110, the engine control systems 112, the electrical loads 108, and the pneumatic loads 106. The power management controller 116 is configured for distributing loads, such as the pneumatic loads 106 and/or the electrical loads 108 between the main power source 102 and auxiliary power source 104. In some embodiments, loads are distributed so as to minimize fuel consumption of the aircraft.

In some embodiments, loads are distributed as a function of thermal efficiencies. Thermodynamic models are used to determine which one of the main power source 102 and auxiliary power source 104 should bear the loads so as to obtain the best thermal efficiency for the aircraft.

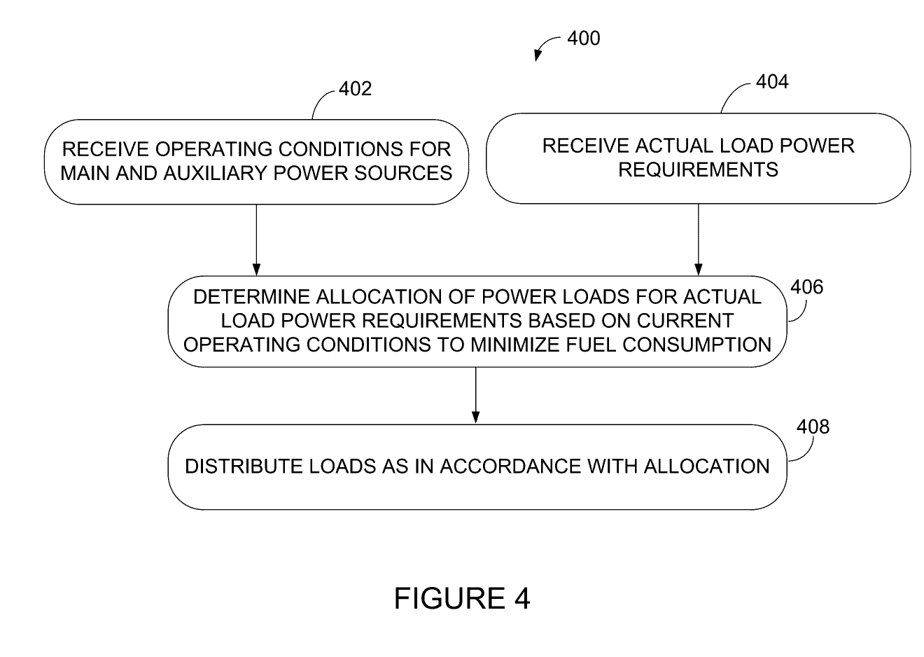

Referring to FIG. 4, there is illustrated an example method 400 for power management in the aircraft 100, as performed by the power management controller 116. At step 402, operating conditions for the auxiliary power source 104 and the main power source 102 are received. Operating conditions comprise, for example, air mass flow, fuel mass flow, injection pressure, intake pressure, engine speed, various engine-related temperatures, and any other parameter associated with an engine that relates to its operation. These may be received at the power management controller 116, for example, from the engine control systems 112. For the main power source 102, the operating conditions may be received from a FADEC (not shown) whereas for the auxiliary power source 104, the operating conditions may be received from a separate auxiliary power unit (APU) controller.

Concurrently or sequentially to step 402, actual load power requirements of the aircraft 100 are also received. The actual load power requirements correspond to the power needs for supporting the active or soon-to-be active loads of the aircraft 100. The power needs may generally refer to a combination of an air bleed flow/pressure demand on a compressor, based on cabin conditions plus electrical generator demands, translated to a shaft power demand on the accessory gearbox of the engine.

In some embodiments, load power needs are received as a delta between previous load power needs and current load power needs. For example, if a new electrical load, such as an electric starter for a second main engine, is commanded to start, the delta power needs correspond to the power needs for starting the second main engine. However, if at the same time as starting the second main engine another electrical load is shutoff, for example a ventilation system, then the delta power needs=the previous power needs+the power needs for starting the second main engine−the power needs for the ventilation system. Alternatively, the power needs are provided as an absolute value, as of the time the load power requirements are received.

The actual load power requirements for the electrical loads 108 and the pneumatic loads 106 may be received separately or together. Receiving the actual load power requirements, as per step 404, may comprise retrieving the actual load power requirements from the loads 106, 108, from the aircraft control system 110, and/or from another source. Alternatively, the power management controller 116 may be configured to retrieve or receive data indicative of active or soon-to-be active loads and determining, using stored data, the corresponding power requirements for each load.

At step 406, allocation of the power loads is determined so as to minimize fuel consumption. Power load allocation is determined for the actual load power requirements, based on the current operating conditions. System flow and electrical demands of the aircraft are interpreted at a high level, and it is determined how they may be satisfied while minimizing the impact of secondary power extraction from the main power source or the auxiliary power source, and choosing the best source or a combination of sources to yield minimum fuel flow. At step 408, loads are distributed between the main power source 102 and the auxiliary power source 104 so as to minimize fuel consumption and as per the allocation determined at step 406. The method 400 thus selects the lowest available fuel flow between the main power source 102 and the auxiliary power source 104, or a combination thereof to reach the lowest available fuel flow, for the required propulsion thrust, bleed air conditions, and shaft power extract. Maximum thermal or overall efficiency may, in some cases, also be indicators of this condition, dependent on the system configuration. For example, thermal efficiencies from the auxiliary power source 104 and the main power source 102 may be compared for the current load power requirements using the received operating conditions. Thermodynamic models may be stored in the power management controller 116 or in a remote storage device accessible by the power management controller 116 and used to compare thermal efficiencies of the power sources 102, 104. The thermal efficiency of each power source 102, 104 may be modeled using a given thermodynamic model, based on a specific set of operating conditions and power requirements. For example, the thermal efficiency (TE) of each power source 102, 104 may be determined by considering how much thermal energy, or heat Qᵢₙ is converted into mechanical energy, or work Wₒᵤₜ and is not dissipated as waste heat Qₒᵤₜ as follows:

$$TE = \frac{{W}_{out}}{{Q}_{in}} = 1 - \frac{{Q}_{out}}{{Q}_{in}}$$

When the current load distribution between the main power source 102 and the auxiliary power source 104 does not correspond to the optimal setup for thermal efficiencies, the loads 106, 108 are redistributed as a function of thermal efficiencies, as per step 408. For example, if the current load distribution corresponds to having all of the loads 106, 108 powered by the main power source 102 but the thermal efficiency of the auxiliary power source 104 is deemed to be greater for the current operating conditions, a redistribution occurs. Similarly, if the current load distribution corresponds to some loads 106, 108 on the main power source 102 and some loads 106, 108 on the auxiliary power source 104 but the thermal efficiency of the main power source 102 is found to be greater for the current operating conditions, a redistribution occurs.

Step 406 of determining a load allocation and step 408 of distributing the loads may be configured to take place continuously throughout the flight, from the time the aircraft is initially powered up until it powers down completely. Alternatively, steps 406, 408 may be performed periodically throughout the flight, at a regular frequency based on time, distance traveled, aircraft fuel consumed, or any other parameter that may be used to trigger the steps. Also alternatively, or in combination therewith, steps 406, 408 may be performed upon a specific trigger, which may be based on a flight regime, an engine operating condition, an aircraft operating condition, a sensor measurement, or the like. In some embodiments, a change in actual load power requirements, alone or in combination with another factor, may trigger steps 406 and 408.

Computer cycle match synthesis models may be used to predict fuel consumption for the main power source 102 and the auxiliary power source 104. For example, modeling may be performed based on flight condition, throttle setting, and the installation extractions, which include aircraft bleed air flow demand for pneumatic systems and generator power extraction. Thermodynamic process calculation routines may be used for individual engine components (i.e. compressors, combustion, turbine etc.) and executed in a specified order appropriate for the engine configuration. They can predict fuel flow as well as other engine parameters, particularly when calibrated against engine and component test results. Such models may therefore be used for predicted fuel flow comparisons to select the best power option for the loads.

In some embodiments, partial derivative and/or state variable models are used to determine allocation of the power loads. Such models have a large number of partial derivative matrices for delta fuel flow vs delta power extraction and delta bleed extraction for main power source and auxiliary power source conditions, covering the aircraft's anticipated mission envelope. Calculation speed and reliability can be higher than when using cycle match models since they do not rely on doing the complex cycle match calculations within the control computer. Alternatively maps or tables of various key parameters derived from cycle synthesis models may also be used instead of the models directly to save even more memory and CPU.

In some embodiments, the performance of an Environmental Control System (ECS) may be modelled in a manner similar as that of the main power source 102 and the auxiliary power source 104. The ECS may be responsible for most of the inflight use of engine bleed-air and comprise elements that can be modelled using basic thermodynamic processes. The ECS model may thus be used to determine power load allocation. For example, ECS demand for cabin conditioning may be minimized based on predicted bleed outlet conditions (i.e. pressure, temperature) for both the main power source 102 and the auxiliary power source 104 by running the ECS model. Then the fuel flow for each system combination, such as auxiliary power source combined with ECS and main power source combined with ECS, may be predicted by running the models in turn to select the best source.

In some embodiments, it may be found that in some flight operating conditions, the fuel flow of the auxiliary power source 104 is lower than the change in fuel flow of the main power source 102 to provide the required aircraft system loads (bleed and electrical power) with the required power. Specifically, large inefficiencies in main bleed extraction from the main power source 102 occur when the propulsion engines are unable to meet system pressure demands on mid stage bleed and must switch to high stage bleed. High stage bleed generally exceeds system design requirements and the main power source 102 must be both throttled and cooled to match what is required by the aircraft 100. This can occur during cruise at very high altitudes and low weight, or during hold, descent, and idle/taxi situations.

For example, when the main engine throttles are retarded to initiate descent, engine pressures of the main power source 102 fall and the air valves on the engine switch to high stage bleed. The power management controller 116 may thus be configured to consider fuel consumption/fuel flow during specific flight regimes, such as during descent, or during specific engine operating conditions, such as when the main power source 102 switches to high stage bleed. The pneumatic loads 106 may be progressively transferred from the main power source 102 to the auxiliary power source 104 by commanding the engine control systems 112 and/or the aircraft control systems 110 to open an isolation valve of the auxiliary power source 104 and close an isolation valve of the main power source 102 until system pressure falls enough to allow the auxiliary power source check valve to open and to allow the auxiliary power source 104 to deliver air to the pneumatic system. This process continues until the auxiliary power source 104 reaches full pneumatic load or the main power source bleed valves are completely shut. Should the main power source 102 be throttled up again due to a break in the descent, it may be economical, in terms of fuel consumption, to leave the auxiliary power source 104 supporting the pneumatic loads 106.

In another example, during taxi, the auxiliary power source 104 may be supporting the pneumatic loads 106 and the main power source bleed isolation valves are closed. After the main power source 102 spools up, it may be determined that the intermediate stage bleed can meet system pressure requirements. Therefore, after a suitable delay, for example to allow for take-off and initial climb throttle transients, the main power source isolation valve may be progressively opened. Subsequently, the auxiliary power source check valve may be closed and the auxiliary power source 104 may be shut down. The decision to shut down the auxiliary power source 104 may be based on time since the main power source isolation valve has opened, or it may be based on data indicating that take-off is completed and the aircraft is now in climb mode.

Therefore, in some embodiments, when a flight regime is entered, and this flight regime is known to result in a situation where the fuel flow consumptions of the main power source 102 and/or the auxiliary power source 104 change, the power management controller 116 may compare current fuel consumption of the power sources 102, 104 and reallocate loads so as to optimize fuel consumption of the aircraft 100.

In some embodiments, sensing devices are provided on the main power source bleed valves or pressure valves to determine when the switch from intermediate to high stage bleed occurs. Such sensor measurements may be received by, for example, the aircraft control systems and/or the engine control systems 112 and transmitted to the power management controller 116.

In some embodiments, the flight regime status is sent to the power management controller 116 via the aircraft control systems 110. For example, the aircraft control systems 110 may send information to the power management controller 116 in anticipation of a given flight regime, which may be used to start-up the auxiliary power source 104 and have it ready to accept load. Similarly, information about an upcoming flight regime may also be used to transfer the loads back to the main power source 102 and shut down the auxiliary power source 104.

Electrical loads 108 may also be distributed to the auxiliary power source 104, in part or in full, using the same principle of fuel consumption. In some embodiments, electrical loads 108 are only allocated to the auxiliary power source 104 when the auxiliary power source 104 is already active, for example if it has been started up to take on the pneumatic loads 106. The distribution system of the aircraft 100 allows the electrical loads 108 to be selectively distributed between the main power source 102 and the auxiliary power source 104 to obtain the overall most efficient distribution of power between the sources 102, 104 so as to minimize fuel consumption.

In some embodiments, loads are distributed in order to maximize thrust or minimize turbine temperature on the main power source 102. This may occur, for example, if take-off and climb/maximum continuous main power source power are indicated by the aircraft commands 114 (i.e. the throttle) and confirmed by the aircraft control systems 110 (i.e. the FMS). In such a circumstance, the power management controller 116 may transfer loads to the auxiliary power source 104. Once the FMS indicates that stable flight is anticipated at efficient engine conditions for some time, the auxiliary power source 104 is shut down to conserve fuel unless there is a need to bring it on line to act as an emergency generator. In some embodiments, distributing loads comprises minimizing a period of time with the auxiliary power source 104 idling and the main power source 102 powering all of the pneumatic load 106.

For an all-electric auxiliary power source 104 which can share with the main power source 102 engine-mounted generators or starter generators, the electrical load optimization routine based on comparing fuel consumption via locally executed models can be employed to distribute the load most efficiently. For example, when the main power source 102 is operating at part power and the fuel consumption of the auxiliary power source 104 is calculated to be better than the change in fuel flow of the main power source 102 for providing the required aircraft system loads (bleed and electrical power) with power, the power management controller 116 will transfer the maximum amount of load to the auxiliary power source 104.

The power management controller 116 may be implemented in various manners, such as in software on a processor, on a programmable chip, on an Application Specific Integrated Chip (ASIC), or as a hardware circuit. In some embodiments, the power management controller 116 is implemented in hardware on a dedicated circuit board located inside an Electronic Engine Controller (EEC) or an Engine Control Unit (ECU). The EEC or ECU may be provided as part of a Full Authority Digital Engine Control (FADEC) of an aircraft. In some cases, a processor may be used to communicate information to a circuit of the power management controller 116, such as operating conditions and/or actual load power requirements. In other embodiments, the power management controller 116 is implemented in a digital processor.

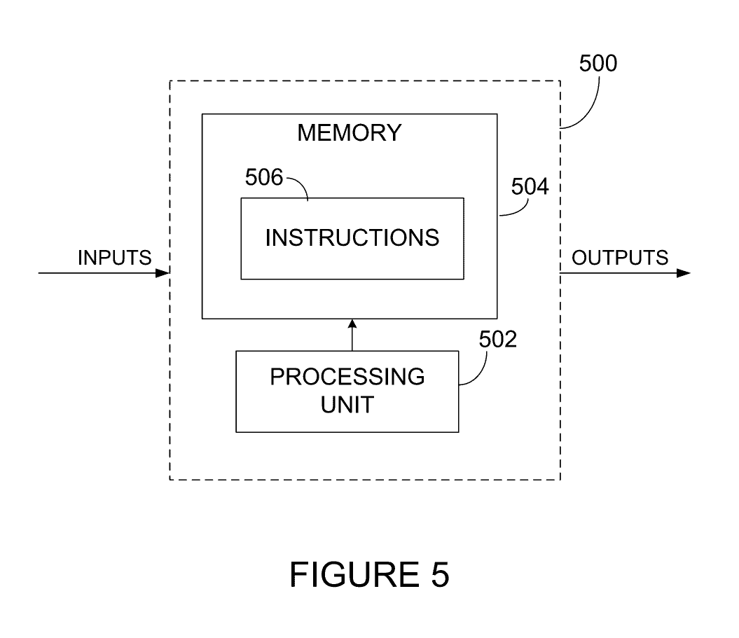

An example embodiment of the power management controller 116 is illustrated in FIG. 5. A computing device 500 may comprise, amongst other things, a processing unit 502 and a memory 504 which has stored therein computer-executable instructions 506. The processing unit 502 may comprise any suitable devices to implement the method 400 such that instructions 506, when executed by the computing device 500 or other programmable apparatus, may cause the functions/acts/steps specified in the methods described herein to be executed. The processing unit 502 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 504 may comprise any suitable machine-readable storage medium. The memory 504 may comprise non-transitory computer readable storage medium such as, for example, but not limited to, an electronic, magnetic, optical, electromagnetic, infrared, or semiconductor system, apparatus, or device, or any suitable combination of the foregoing. The memory 504 may include a suitable combination of any type of computer memory that is located either internally or externally to device 500, such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory may comprise any storage means (e.g., devices) suitable for retrievably storing machine-readable instructions executable by processing unit.

In some embodiments, the computing device 500 sends one or more control signals directly to valves for opening and closing air flow to the pneumatic loads 106. In other embodiments, the control signals are sent to an intermediary unit, such as the aircraft control systems 110 and/or the engine control systems 112, which translates the control signals sent by the computing device 500 into signals to be sent to the valves.

The methods and systems for aircraft power management described herein may be implemented in a high level procedural or object oriented programming or scripting language, or a combination thereof, to communicate with or assist in the operation of a computer system, for example the computing device 500. Alternatively, the methods and systems for aircraft power management may be implemented in assembly or machine language. The language may be a compiled or interpreted language. Program code for implementing the methods and systems for aircraft power management may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for aircraft power management may also be considered to be implemented by way of a non-transitory computer-readable storage medium having a computer program stored thereon. The computer program may comprise computer-readable instructions which cause a computer, or more specifically the processing unit 502 of the computing device 500, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Various aspects of the methods and systems for detecting the shaft event may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for power management in an aircraft having at least one main power source for providing propulsive power to the aircraft and at least one auxiliary power source for providing auxiliary power to the aircraft, the method comprising:
while in flight, receiving auxiliary power source current operating conditions from at least one auxiliary power source and receiving main power source current operating conditions from at least one main power source;
receiving an actual load power requirement for the aircraft;
determining an allocation of power loads of the aircraft for the actual load power requirements, based on the current operating conditions, to minimize fuel consumption of the aircraft; and
distributing the power loads of the aircraft between the at least one auxiliary power source and the at least one main power source in accordance with the allocation as determined.

2. The method of claim 1, wherein determining an allocation of power loads to minimize fuel consumption comprises comparing thermal efficiencies of the at least one auxiliary power source and the at least one main power source.

3. The method of claim 1, wherein determining an allocation of power loads to minimize fuel consumption comprises minimizing a fuel flow for a required propulsion thrust, bleed air conditions, and shaft power extraction.

4. The method of claim 1, wherein determining an allocation and distributing the power loads is triggered by a change to the actual load requirement for the aircraft.

5. The method of claim 1, further comprising shutting down the at least one auxiliary power source when the power loads are fully allocated to the at least one main power source.

6. The method of claim 1, wherein determining an allocation comprises considering a flight regime of the aircraft.

7. The method of claim 1, wherein determining an allocation of power loads comprises transferring a maximum amount of power loads to the at least one auxiliary power source when a fuel consumption of the at least one auxiliary power source is lower than a change in fuel consumption of the at least one main power source for the actual load power requirement.

8. The method of claim 1, wherein determining an allocation of power loads comprises maximizing thrust or minimizing turbine temperature on the at least one main power source while optimizing fuel consumption of the aircraft.

9. The method of claim 1, wherein determining an allocation of the power loads comprises minimizing a period of time with the at least one auxiliary power source idling and the at least one main power source powering all pneumatic loads.

10. A power management system for an aircraft having at least one main power source for providing propulsive power to the aircraft and at least one auxiliary power source for providing auxiliary power to the aircraft, the system comprising:
a processing unit; and
a non-transitory memory communicatively coupled to the processing unit and comprising computer-readable program instructions executable by the processing unit for:
while in flight, receiving auxiliary power source current operating conditions from at least one auxiliary power source and receiving main power source current operating conditions from at least one main power source;
receiving an actual load power requirement for the aircraft;
determining an allocation of power loads of the aircraft for the actual load power requirements, based on the current operating conditions, to minimize fuel consumption of the aircraft; and
distributing the power loads of the aircraft between the at least one auxiliary power source and the at least one main power source in accordance with the allocation as determined.

11. The system of claim 10, wherein determining an allocation of power loads to minimize fuel consumption comprises comparing thermal efficiencies of the at least one auxiliary power source and the at least one main power source.

12. The system of claim 10, wherein determining an allocation of power loads to minimize fuel consumption comprises minimizing a fuel flow for a required propulsion thrust, bleed air conditions, and shaft power extraction.

13. The system of claim 10, wherein determining an allocation and distributing power loads is triggered by a change to the actual load requirement for the aircraft.

14. The system of claim 10, wherein the program instructions are further executable for shutting down the at least one auxiliary power source when the power loads are fully allocated to the at least one main power source.

15. The system of claim 10, wherein determining an allocation comprises considering a flight regime of the aircraft.

16. The system of claim 10, wherein determining an allocation of power loads comprises transferring a maximum amount of power loads to the at least one auxiliary power source when a fuel consumption of the at least one auxiliary power source is lower than a change in fuel consumption of the at least one main power source for the actual load power requirement.

17. The system of claim 10, wherein determining an allocation of power loads comprises maximizing thrust or minimizing turbine temperature on the at least one main power source while optimizing fuel consumption of the aircraft.

18. The system of claim 10, wherein determining an allocation of the power loads comprises minimizing a period of time with the at least one auxiliary power source idling and the at least one main power source powering all of pneumatic load.

19. A power management system for an aircraft having at least one main power source for providing propulsive power to the aircraft and at least one auxiliary power source for providing auxiliary power to the aircraft, the system comprising:
at least one main power source;
at least one auxiliary power source; and
a controller configured for:
while in flight, receiving auxiliary power source current operating conditions from the at least one auxiliary power source and receiving main power source current operating conditions from the at least one main power source;
receiving an actual load power requirement for the aircraft;
determining an allocation of power loads of the aircraft for the actual load power requirements, based on the current operating conditions, to minimize fuel consumption of the aircraft; and
distributing the power loads of the aircraft between the at least one auxiliary power source and the at least one main power source in accordance with the allocation as determined.

20. The system of claim 19, wherein the at least one main power source is a gas turbine engine and the at least one auxiliary power source is a turbo-compounded or turbo compressed rotary engine.
